(19) United States
(12) Patent Application Publication
(10) Pub. No.: US 2018/0370406 A1
(43) Pub. Date: Dec. 27, 2018

(54) HEEL PAD FOR A FLOOR MAT, FLOOR MAT INCLUDING A REPLACEABLE HEEL PAD SECTION, AND METHOD OF PROTECTING A FLOOR MAT USING A HEEL PAD

(71) Applicant: Innovative Product Management, LLC, Columbus, OH (US)

(72) Inventor: Cheriyan THOMAS, Farmington, CT (US)

(73) Assignee: Innovative Product Management, LLC, Columbus, OH (US)

(21) Appl. No.: 16/003,537

(22) Filed: Jun. 8, 2018

Related U.S. Application Data
(60) Provisional application No. 62/525,358, filed on Jun. 27, 2017.

(51) Int. Cl. B60N 3/04; B32B 3/26

(52) U.S. Cl. CPC B60N 3/048; B32B 2471/04; B60N 3/044; B32B 3/263

(57) ABSTRACT

A heel pad for a floor mat of a motor vehicle may comprise a first section, a second section, and an engagement structure. The first section includes a first material. The second section includes a second material and may be disposed along a periphery of the first section. The engagement structure is below at least one of the first section and the second section. A method of protecting a floor mat of a motor vehicle may comprise attaching the heel pad to a portion of the floor mat below a pedal of the motor vehicle so as to be situated between a heel of a driver of the motor vehicle and the floor mat.

### CROSS-REFERENCE TO RELATED APPLICATION

The present application claims priority under 35 U.S.C. § 119 to U.S. Provisional No. 62/525,358, filed Jun. 27, 2017, the entire content of which is hereby incorporated herein by reference.

### BACKGROUND

### Field

The present disclosure relates to floor mats for motor vehicles and the protection thereof.

### Description of Related Art

The mat on the floor of the driver's side of a motor vehicle, such as an automobile, may become worn and/or matted from the repetitive contact with the driver's feet. For instance, the portion of a floor mat below the gas pedal may become worn and subsequently develop a hole from repeated contact with the heel of the right foot. In another instance, the portion of a floor mat below the clutch pedal (for a manual transmission vehicle) may become worn and subsequently develop a hole from repeated contact with the heel of the left foot. In either instance, the mat on the driver's side may need to be replaced in a relatively short period of time compared to the other mats in the motor vehicle. Furthermore, because a new replacement mat may adversely contrast with the other older mats in a motor vehicle, a vehicle owner may need to replace all of the mats at the same time to obtain a consistent, aesthetic appearance. Accordingly, the premature wear of a mat may be not only unsightly but also inconvenient and costly.

### SUMMARY

A heel pad for a floor mat of a motor vehicle may comprise a first section, a second section, and an engagement structure. The first section includes a first material. The second section includes a second material and may be disposed along a periphery of the first section. The engagement structure is below at least one of the first section and the second section.

The first material may be a different type from the second material. For example, the first material may be of a fibrous construction, and the second material may be a polymer. Alternatively, the first material may be a same type as the second material.

The first section may have a thickness of 0.5 inches or less. The second section may have a tapered edge. In addition, the second section may be more dense than the first section.

The engagement structure may be in a form of a plurality of protrusions (e.g., teeth). In another instance, the engagement structure may be in a form of a plurality of hooks (e.g., to establish a hook-and-loop fastening arrangement). In another instance, the engagement structure may be in a form of an adhesive. In another instance, the engagement structure may include a magnet.

The second section may include an upper surface and an opposing lower surface. The upper surface of the second section may define a depression. The first section may be seated in the depression. The engagement structure may be attached to the opposing lower surface of the second section.

Alternatively, the heel pad may further comprise a support structure including an upper surface and an opposing lower surface. The first section and the second section may be attached to the upper surface of the support structure. The engagement structure may be attached to the opposing lower surface of the support structure.

A floor mat of a motor vehicle may comprise a flexible laminar body defining a recess configured to receive a replaceable protective pad. The floor mat may further comprise an engagement structure within the recess. The engagement structure may include at least one of a plurality of male members, a plurality of female members, a hook portion of a hook-and-loop fastener, a loop portion of the hook-and-loop fastener, an adhesive, and a magnet.

The flexible laminar body may include a backing structure and a fibrous layer on the backing structure. The fibrous layer may define an opening as the recess. The opening may expose a sector of the backing structure. The sector of the backing structure exposed by the opening may include the engagement structure. Alternatively, the flexible laminar body and the engagement structure may be integrally formed.

The recess may include a shallow pocket that is overlapped by the flexible laminar body. The shallow pocket may help seat the replaceable protective pad. The floor mat may further comprise a heel pad seated within the recess as the replaceable protective pad.

A method of protecting a floor mat of a motor vehicle may comprise attaching a heel pad to a portion of the floor mat below a pedal of the motor vehicle so as to be situated between a heel of a driver of the motor vehicle and the floor mat. The attaching may include securing the heel pad to the portion of the floor mat that is primarily subject to repetitive contact with the heel of the driver.

### BRIEF DESCRIPTION OF THE DRAWINGS

The various features and advantages of the non-limiting embodiments herein may become more apparent upon review of the detailed description in conjunction with the accompanying drawings. The accompanying drawings are merely provided for illustrative purposes and should not be interpreted to limit the scope of the claims. The accompanying drawings are not to be considered as drawn to scale unless explicitly noted. For purposes of clarity, various dimensions of the drawings may have been exaggerated.

FIG. 1 is a plan view of a heel pad according to an example embodiment.

FIG. 2 is a side cross-sectional view of the heel pad of FIG. 1.

FIG. 3 is a plan view of various alternative configurations for a heel pad according to an example embodiment.

FIG. 4 is a plan view of another heel pad according to an example embodiment.

FIG. 5 is a plan view of another heel pad according to an example embodiment.

FIG. 6 is a plan view of another heel pad according to an example embodiment.

FIG. 7 is a plan view of another heel pad according to an example embodiment.

FIG. 8 is a plan view of another heel pad according to an example embodiment.

FIG. 9 is a plan view of another heel pad according to an example embodiment.

FIG. 10 is a plan view of another heel pad according to an example embodiment.

FIG. 11 is a plan view of another heel pad according to an example embodiment.

FIG. 12 is a plan view of another heel pad according to an example embodiment.

FIG. 13 is a plan view of another heel pad according to an example embodiment.

FIG. 14 is a plan view of another heel pad according to an example embodiment.

FIG. 15 is a plan view of another heel pad according to an example embodiment.

FIG. 16 is a plan view of another heel pad according to an example embodiment.

FIG. 17 is a plan view of another heel pad according to an example embodiment.

FIG. 18 is a plan view of another heel pad according to an example embodiment.

FIG. 19 is a plan view of another heel pad according to an example embodiment.

FIG. 20 is a plan view of another heel pad according to an example embodiment.

FIG. 21 is a plan view of another heel pad according to an example embodiment.

FIG. 22 is a plan view of a floor mat with a replaceable heel pad section according to an example embodiment.

### DETAILED DESCRIPTION

It should be understood that when an element or layer is referred to as being “on,” “connected to,” “coupled to,” or “covering” another element or layer, it may be directly on, connected to, coupled to, or covering the other element or layer or intervening elements or layers may be present. In contrast, when an element is referred to as being “directly on,” “directly connected to,” or “directly coupled to” another element or layer, there are no intervening elements or layers present. Like numbers refer to like elements throughout the specification. As used herein, the term “and/or” includes any and all combinations of one or more of the associated listed items.

It should be understood that, although the terms first, second, third, etc. may be used herein to describe various elements, components, regions, layers and/or sections, these elements, components, regions, layers, and/or sections should not be limited by these terms. These terms are only used to distinguish one element, component, region, layer, or section from another region, layer, or section. Thus, a first element, component, region, layer, or section discussed below could be termed a second element, component, region, layer, or section without departing from the teachings of example embodiments.

Spatially relative terms (e.g., “beneath,” “below,” “lower,” “above,” “upper,” and the like) may be used herein for ease of description to describe one element or feature's relationship to another element(s) or feature(s) as illustrated in the figures. It should be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” may encompass both an orientation of above and below. The device may be otherwise oriented (rotated 90 degrees or at other orientations) and the spatially relative descriptors used herein interpreted accordingly.

The terminology used herein is for the purpose of describing various embodiments only and is not intended to be limiting of example embodiments. As used herein, the singular forms “a,” “an,” and “the” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments should not be construed as limited to the shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which example embodiments belong. It will be further understood that terms, including those defined in commonly used dictionaries, should be interpreted as having a meaning that is consistent with their meaning in the context of the relevant art and will not be interpreted in an idealized or overly formal sense unless expressly so defined herein.

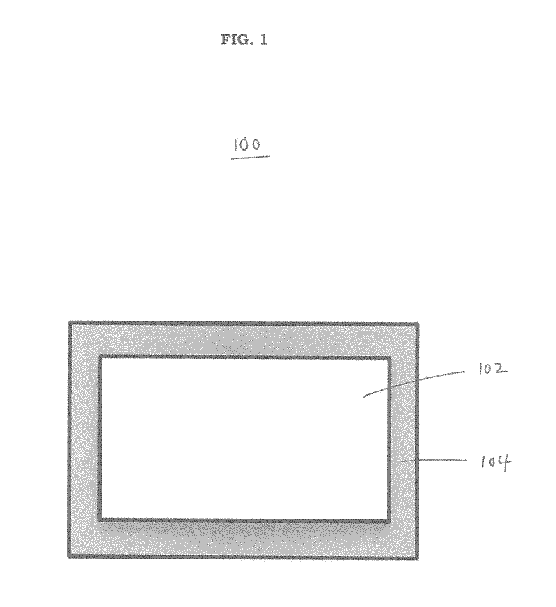

FIG. 1 is a plan view of a heel pad according to an example embodiment. Referring to FIG. 1, the heel pad 100 is designed to protect a floor mat of a motor vehicle and can be secured with relative ease to a portion of the floor mat that experiences (or is expected to experience) accelerated wear. For instance, the heel pad 100 can be secured to a portion of the floor mat below the gas pedal where the heel of the driver's right foot would typically contact the floor mat when the gas pedal is pressed. As a result, the floor mat can be protected from the repeated contacts with the heel of the driver's right foot, which can create a hole in the floor mat if such contacts are not mitigated.

Similarly, the heel pad 100 can be secured to a portion of the floor mat below the clutch pedal (for a manual transmission vehicle) where the heel of the driver's left foot would typically contact the floor mat when the clutch pedal is pressed. As a result, the floor mat can be protected from the repeated contacts with the heel of the driver's left foot, which can create a hole in the floor mat if such contacts are not mitigated.

The floor mat to be protected by the heel pad discussed herein may be an existing standard floor mat or a floor mat manufactured to accommodate the heel pad (subsequently discussed in further detail). The floor mat may be a carpeted mat or one formed of another material (e.g., polymer mat). In addition, it should be understood that the floor mat discussed herein for a motor vehicle may also be referred to as a “car mat.”

The heel pad 100 includes a first area 102 and a second area 104. The first area 102 may be a carpeted section of the heel pad 100. The carpeted section corresponding to the first area 102 may be made of a material that matches (e.g., same color, same texture, same fiber type) the material of the underlying floor mat. Alternatively, the material of the carpeted section corresponding to the first area 102 may be any material of suitable durability that can be aesthetically coordinated with the material of the underlying floor mat. The material for the carpeted section is not particularly limited and may include, for instance, nylon. In another instance, the first area 102 may be formed of a polymer (e.g., rubber). In an example embodiment, the first area 102 is 50 square inches or less.

The second area 104 of the heel pad 100 is a transitional section that is designed to ease the change in height from the underlying floor mat to the carpeted section of the heel pad 100. In particular, the part of the second area 104 adjacent to the first area 102 tapers in thickness in an outward direction toward the periphery of the second area 104. The transitional section corresponding to the second area 104 may be formed of a polymer (e.g., soft plastic, rubber). Alternatively, the transitional section corresponding to the second area 104 may be a stitched or woven region that is smaller in thickness than the first area 102. The second area 104 may be more dense than the first area 102.

The appearance of the second area 104 may be tailored to coordinate with the appearance of the first area 102 in an aesthetically pleasing manner. For instance, the color of the first area 102 and the second area 104 may be one that is intended to blend in with the underlying floor mat, although example embodiments are not limited thereto. Notably, the heel pad 100 may be manufactured in a variety of colors, patterns, and shapes to match the underlying floor mat or designed to otherwise appeal to a customer in other aspects (e.g., academic affiliations, professional affiliations, political affiliations, ethnic/national affiliations, activity/social/sports affiliations, or other manners of self-expression).

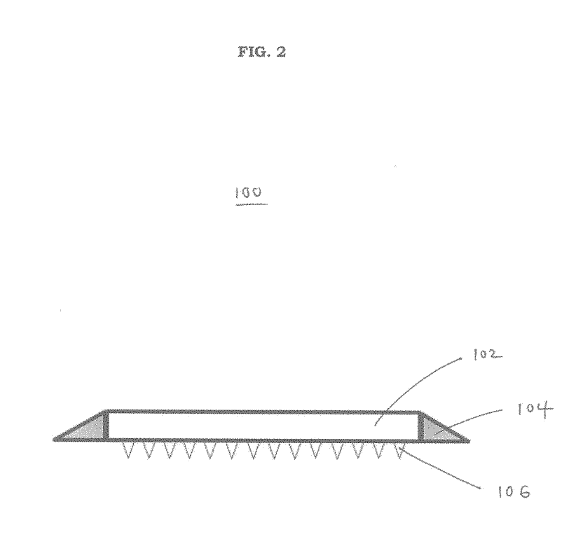

FIG. 2 is a side cross-sectional view of the heel pad of FIG. 1. Referring to FIG. 2, the first area 102 of the heel pad 100 may have a relatively uniform thickness, while the second area 104 may have a thickness that tapers towards the periphery of the heel pad 100. The thickness of the section of the second area 104 that is adjacent to the first area 102 may be the same as the thickness as the first area 102. Because the upper surface of the second area 104 slopes downward to the floor mat, the chance that a driver's foot will catch the edge of the heel pad 100 (which can create a situation ranging from annoying to dangerous) can be reduced or prevented.

The heel pad 100 additionally includes an engagement structure 106 that is configured to secure the heel pad 100 to a floor mat such that the heel pad 100 remains substantially stationary on the floor mat. As used herein, “substantially stationary” means that, once the heel pad 100 is properly secured to a floor mat, the heel pad 100 will not shift more than 0.5 inches in any direction over the course of forty hours of driving.

The engagement structure 106 of the heel pad 100 may be in the form of a plurality of protrusions. The protrusions may be teeth, spikes, pins, or other similar structures. In addition, the protrusions may have a planar structure and arranged in an orthogonal manner to reduce or prevent a shifting of the heel pad 100 on the floor mat during driving. For instance, a first group of protrusions with planar structures may be oriented in a first direction, while a second group of protrusions with planar structures may be oriented in a second direction that is orthogonal to the first direction. In an example embodiment, protrusions with planar structures may be arranged serially along a bottom edge of the first area 102 such that the protrusions on opposite bottom edges of the first area 102 are parallel to each other while protrusions on adjacent bottom edges of the first area 102 are orthogonal to each other. However, it should be understood that other arrangements are possible.

In lieu of (or in addition to) the above protrusions, the engagement structure 106 of the heel pad 100 may be one that forms a hook-and-loop fastening arrangement with a floor mat. For instance, a plurality of hooks may be attached to the undersurface of the first area 102 as the engagement structure 106 such that the plurality of hooks catch in the material (e.g., loops of fiber) of the floor mat when the heel pad 100 is secured to the floor mat. The plurality of hooks used as the engagement structure 106 may be the same as those in a standard hook-and-loop fastener (e.g., Velcro).

In lieu of (or in addition to) the above protrusions and/or hook-and-loop arrangement, the engagement structure 106 may include an adhesive that enables the heel pad 100 to be secured to a floor mat. For instance, when a floor mat is formed of a polymer, the use of an adhesive as the engagement structure 106 may help to provide the heel pad 100 with a beneficial level of attachment to the floor mat.

The heel pad 100 may include a backing or support structure upon which the first area 102, the second area 104, and the engagement structure 106 are disposed. In such an instance, the first area 102 and the second area 104 will be on an opposite surface of the backing structure from the engagement structure 106. In another instance, the backing structure may be integral with the second area 104 (and, thus, formed of the same material) so as to be a single structure with a central depression or recess within which the first area 102 is seated and with the engagement structure 106 attached to the undersurface of the backing structure.

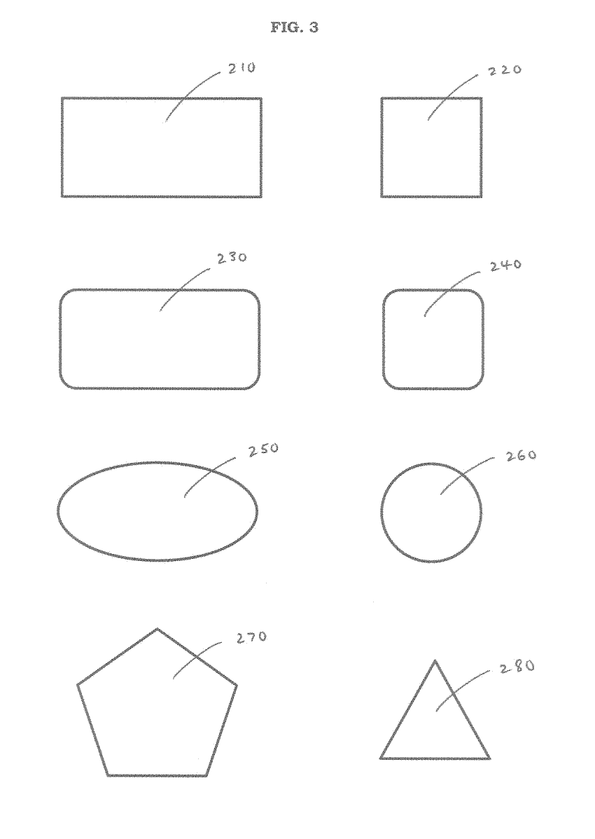

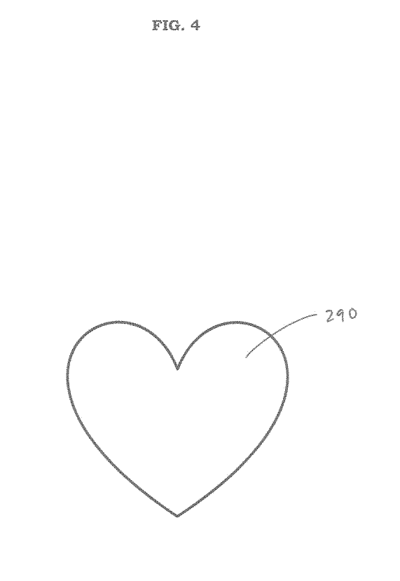

FIG. 3 is a plan view of various alternative configurations for a heel pad according to an example embodiment. For instance, referring to FIG. 3, the heel pad 210 may have a rectangular shape. The heel pad 220 may have a square shape. The heel pad 230 may have a rounded rectangular shape. The heel pad 240 may have a rounded square shape. The heel pad 250 may have an elliptical shape. The heel pad 260 may have a circular shape. The heel pad 270 may have a pentagonal shape. The heel pad 280 may have a triangular shape. The heel pads shown in FIG. 3 (and in subsequently discussed FIGS. 4-21) may be as described in connection with FIGS. 1-2. For instance, the heel pads in FIG. 3 (and in subsequently discussed FIGS. 4-21) may be provided with the first area 102, the second area 104, and the engagement structure 106 of FIGS. 1-2. In addition, the heel pads in FIG. 3 (and in subsequently discussed FIGS. 4-21) may include carpeted sections or be formed of another material (e.g., polymer heel pads). Furthermore, it should be understood that the various shapes and configurations shown and discussed herein are not meant be exhaustive and that other suitable shapes and configurations may be employed.

FIG. 4 is a plan view of another heel pad according to an example embodiment. Referring to FIG. 4, the heel pad 290 may have a heart shape. Because the heel pads disclosed herein can serve both a functional purpose and an aesthetic purpose, the heel pads can be designed to actually be noticed (rather than trying to be subtle and obscure) and changed as desired based on a driver's preferences. In this regard, the heel pad 290 may be red or pink in color, although example embodiments are not limited thereto. The heel pad 290 may appeal to a driver who likes hearts and/or a driver who chooses to use a heart-shaped heel pad for the month of February because of Valentine's Day.

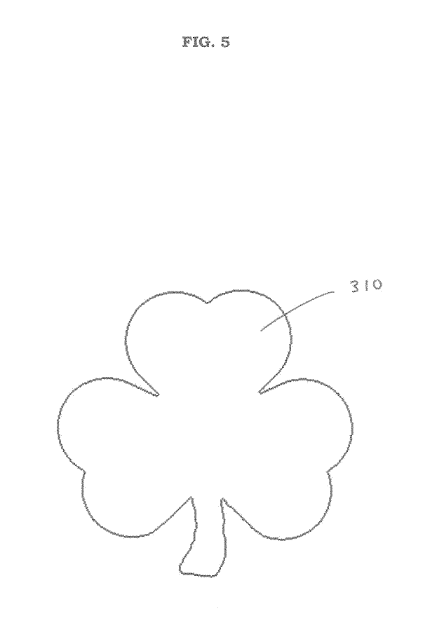

FIG. 5 is a plan view of another heel pad according to an example embodiment. Referring to FIG. 5, the heel pad 310 may have a shamrock shape and may be green in color, although example embodiments are not limited thereto. The heel pad 310 may appeal to a driver who likes the lucky connotation associated with shamrocks, a driver who is Irish, and/or a driver who chooses to use a shamrock-shaped heel pad for the month of March because of St. Patrick's Day.

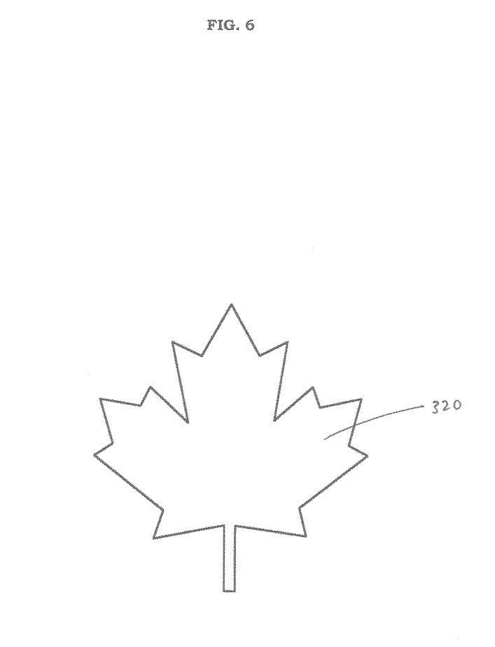

FIG. 6 is a plan view of another heel pad according to an example embodiment. Referring to FIG. 6, the heel pad 320 may have a maple leaf shape, which may appeal to a driver who is Canadian and/or a driver who chooses to use a maple leaf-shaped heel pad for the fall season. In this regard, the heel pad 320 may be provided in a variety of colors, such as red, orange, yellow, green, or brown, although example embodiments are not limited thereto.

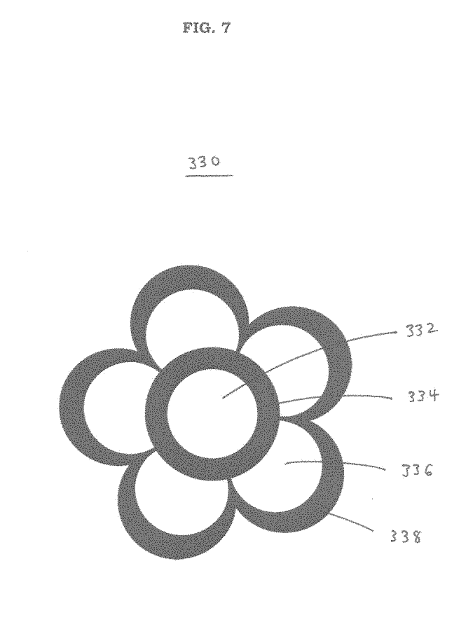

FIG. 7 is a plan view of another heel pad according to an example embodiment. Referring to FIG. 7, the heel pad 330 may have a flower shape. The first area 332 and the third area 336 may be formed of a first material and/or texture, while the second area 334 and the fourth area 338 may be formed of a second material and/or texture to obtain the pertinent contrast. In an example embodiment, the first area 332 and the third area 336 may be as described in connection with the first area 102 in FIGS. 1-2, while the second area 334 and the fourth area 338 may be as described in connection with the second area 104 in FIGS. 1-2. For instance, first area 332 and the third area 336 may be carpeted sections of the heel pad 330, while the second area 334 and the fourth area 338 may be delineating sections of the heel pad 330 formed of a polymer, although example embodiments are not limited thereto. In addition, while the heel pad 330 may colored accordingly resemble a flower from the spring, summer, and/or fall seasons, it should be understood that the shape and color of the heel pad 330 may also be modified to resemble a poinsettia for the winter/Christmas season.

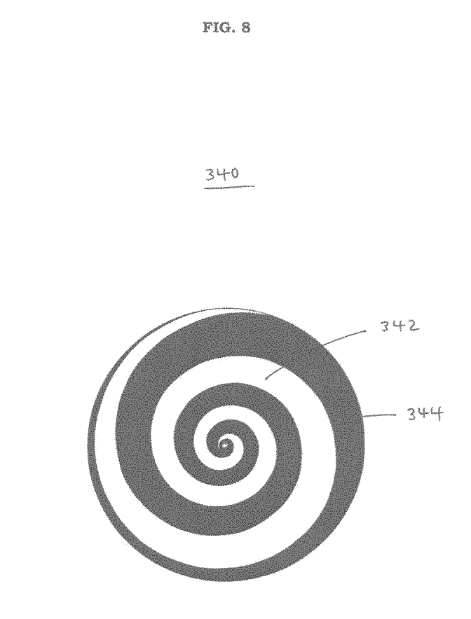

FIG. 8 is a plan view of another heel pad according to an example embodiment. Referring to FIG. 8, the heel pad 340 may have a spiral pattern formed by the first area 342 and the second area 344. The first area 342 may be formed of a first material and/or texture, while the second area 344 may be formed of a second material and/or texture to obtain the pertinent contrast. Although not necessarily disclosed explicitly herein for each applicable example, it should be understood that the material, texture, and/or color of any given area of the heel pads may be varied as needed to obtain the requisite contrast or other appearance.

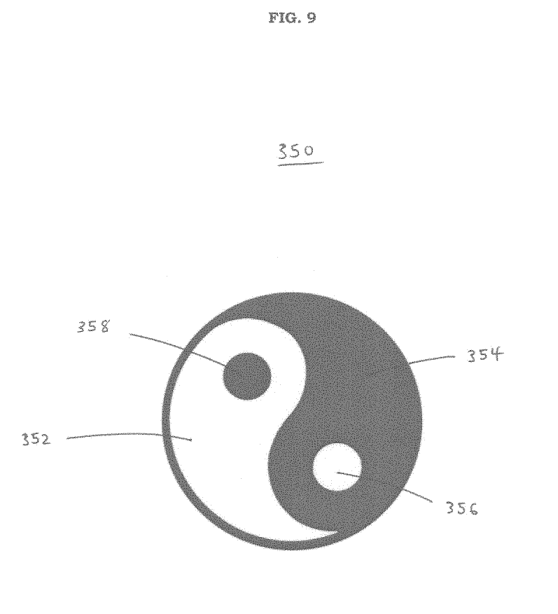

FIG. 9 is a plan view of another heel pad according to an example embodiment. Referring to FIG. 9, the heel pad 350 may have a yin and yang pattern formed by the first area 352, the second area 354, the third area 356, and the fourth area 358.

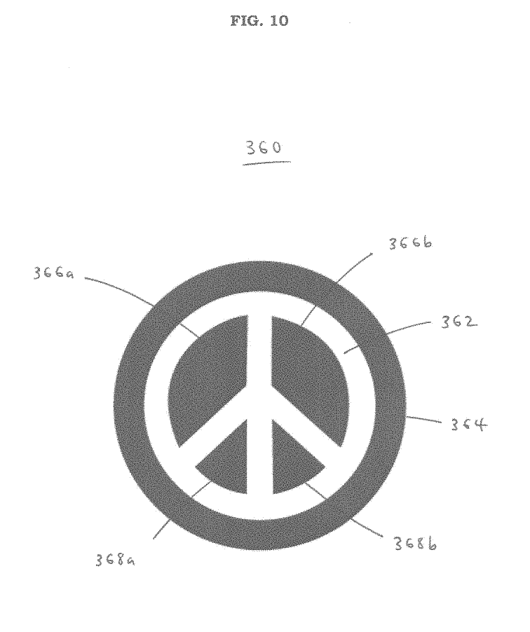

FIG. 10 is a plan view of another heel pad according to an example embodiment. Referring to FIG. 10, the heel pad 360 may have a peace symbol pattern formed by the first area 362, the second area 364, the third area 366a, the fourth area 366b, the fifth area 368a, and the sixth area 368b.

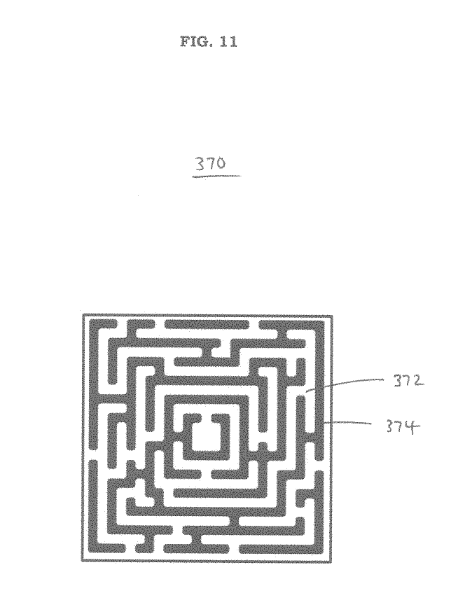

FIG. 11 is a plan view of another heel pad according to an example embodiment. Referring to FIG. 11, the heel pad 370 may have a maze or labyrinth pattern formed by the first area 372 and the second area 374.

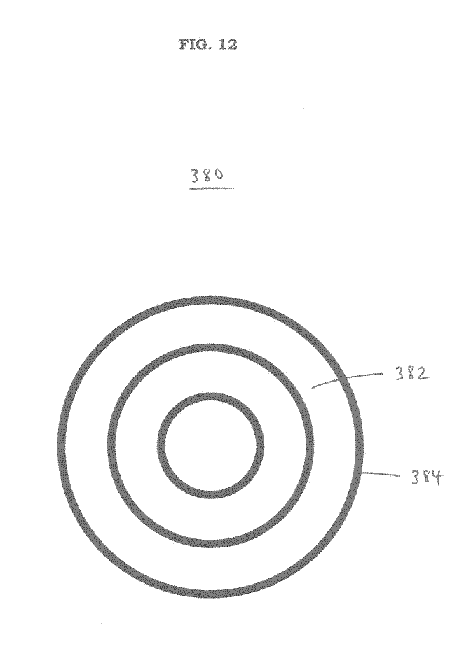

FIG. 12 is a plan view of another heel pad according to an example embodiment. Referring to FIG. 12, the heel pad 380 may have a bullseye pattern formed by the first area 382 and the second area 384. The heel pad 380 may appeal to drivers who engage in target-related activities, such as archers.

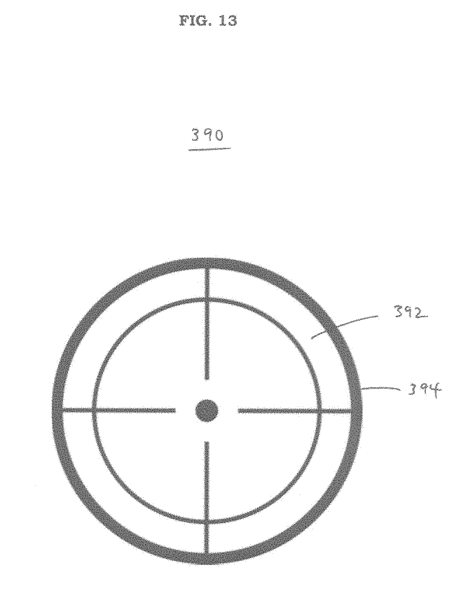

FIG. 13 is a plan view of another heel pad according to an example embodiment. Referring to FIG. 13, the heel pad 390 may have a crosshair pattern formed by the first area 392 and the second area 394. The heel pad 390 may appeal to drivers who use or otherwise have an interest in shooting firearms, such as hunters, paintball hobbyists, video garners, and/or gun enthusiasts.

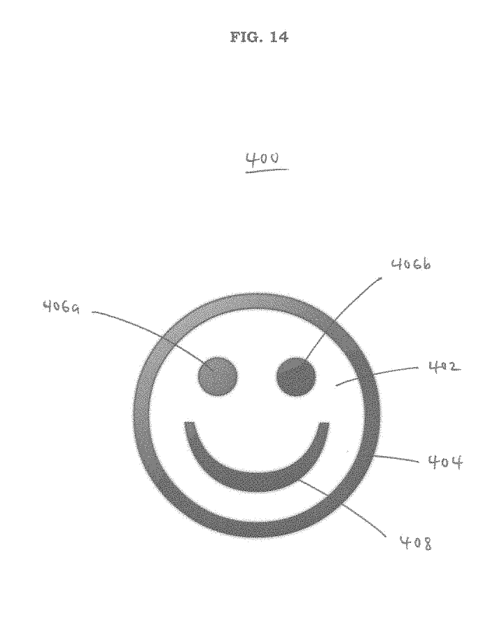

FIG. 14 is a plan view of another heel pad according to an example embodiment. Referring to FIG. 14, the heel pad 400 may have smiley face pattern formed by the first area 402, the second area 404, the third area 406a, the fourth area 406b, and the fifth area 408.

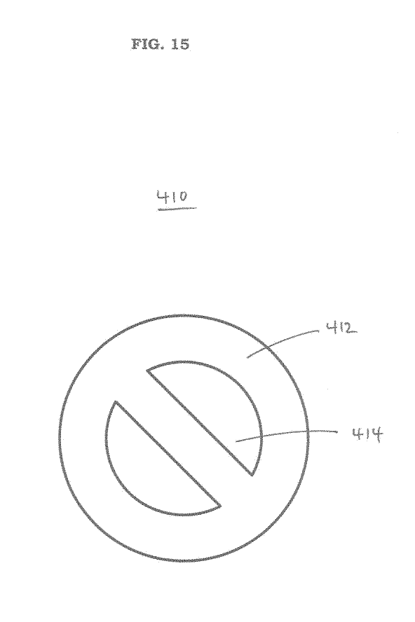

FIG. 15 is a plan view of another heel pad according to an example embodiment. Referring to FIG. 15, the heel pad 410 may have a ban-circle pattern formed by the first area 412 and the second area 414. The heel pad 410 may be configured to allow a picture to be slipped between the first area 412 and the second area 414. A transparent film may also be provided beneath the first area 412 to shield the picture from substances (e.g., moisture, dirt) that may prematurely degrade the picture. In this regard, a driver may use the heel pad 410 not only as a protection for the floor mat but also as an avenue of personal expression to show a displeasure towards an activity, a political figure, and/or a rival sports team.

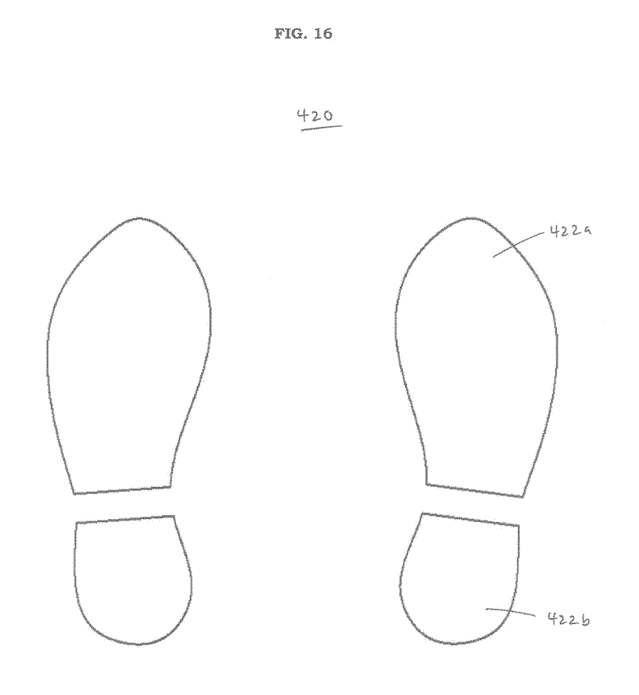

FIG. 16 is a plan view of another heel pad according to an example embodiment. Referring to FIG. 16, the heel pad 420 may have a shoe print pattern formed by the first area 422a and the second area 422b. The heel pad 420 corresponding to the right foot may be secured to the floor mat below the gas pedal, while the heel pad 420 corresponding to the left foot may be secured to the floor mat below the clutch pedal (for manual transmission vehicles). In addition, the heel pad 420 corresponding to each foot may be provided as a single pad (with different materials, textures, and/or colors used to obtain the requisite contrast).

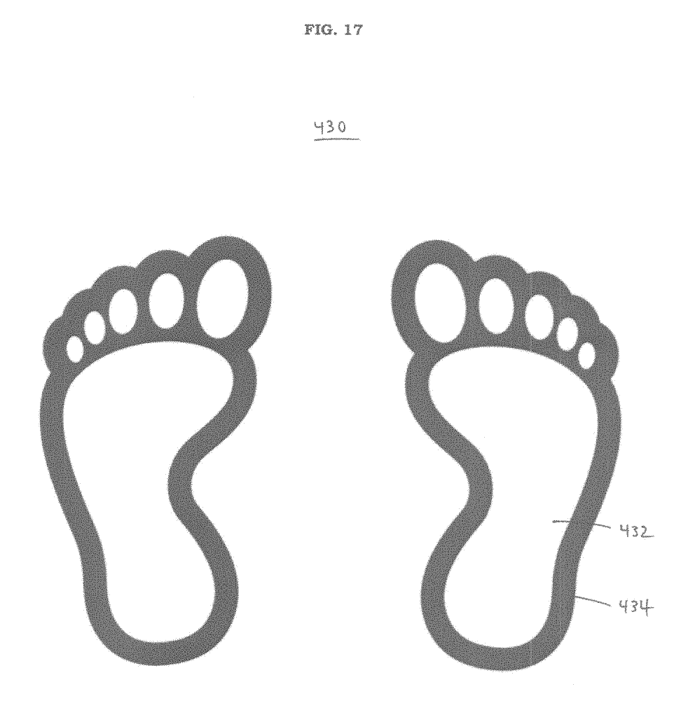

FIG. 17 is a plan view of another heel pad according to an example embodiment. Referring to FIG. 17, the heel pad 430 may have a foot print pattern formed by the first area 432 and the second area 434. The heel pad 430 corresponding to the right foot may be secured to the floor mat below the gas pedal, while the heel pad 430 corresponding to the left foot may be secured to the floor mat below the clutch pedal (for manual transmission vehicles).

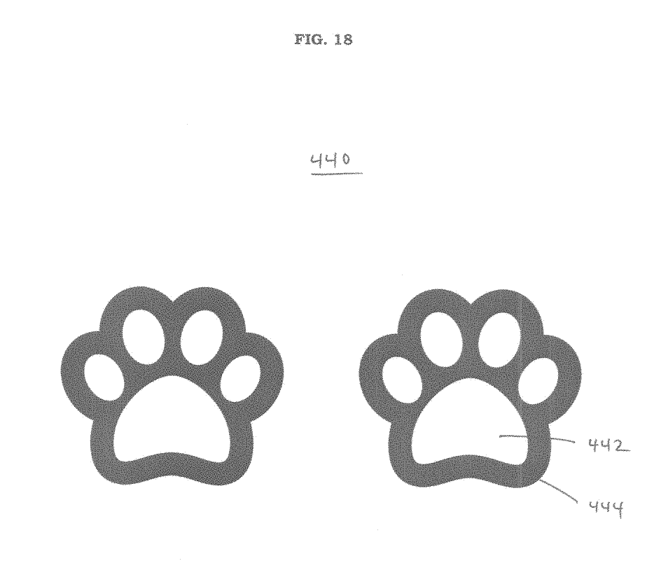

FIG. 18 is a plan view of another heel pad according to an example embodiment. Referring to FIG. 18, the heel pad 440 may have a paw print pattern formed by the first area 442 and the second area 444. The heel pad 440 corresponding to the right foot may be secured to the floor mat below the gas pedal, while the heel pad 440 corresponding to the left foot may be secured to the floor mat below the clutch pedal (for manual transmission vehicles). The heel pad 440 may appeal to drivers who work with, help, or otherwise just like animals, such as veterinarians, animal trainers, animal shelter employees, and pet owners.

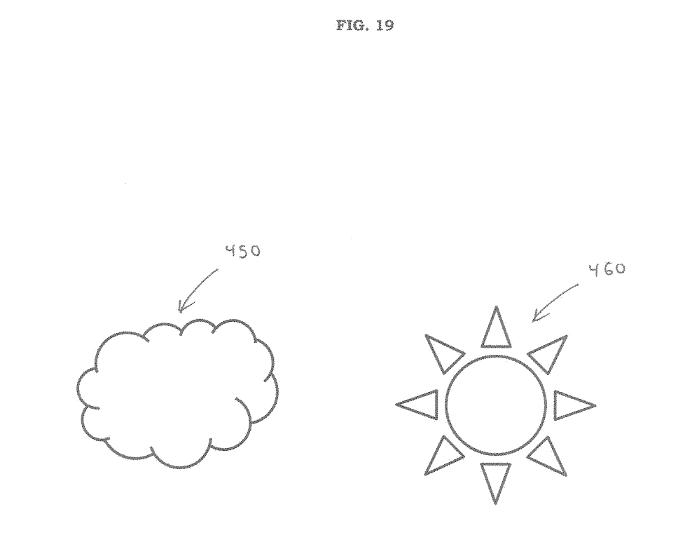

FIG. 19 is a plan view of another heel pad according to an example embodiment. Due to the versatile nature of the heel pads disclosed herein, a variety of pairings and themes are possible. For instance, referring to FIG. 19, the heel pad 450 may be in a form of a cloud, and the heel pad 460 may be in a form of a sun. The heel pad 460 may be provided as a single pad (with different materials, textures, and/or colors used to obtain the requisite contrast). The heel pad 460 may be secured to the floor mat below the gas pedal, while the heel pad 450 may be secured to the floor mat below the brake pedal.

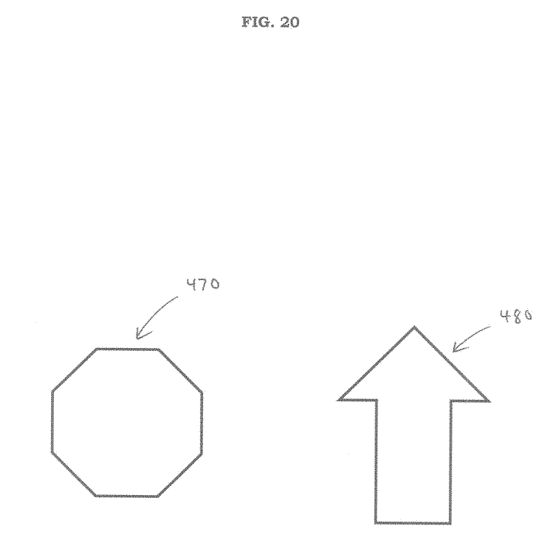

FIG. 20 is a plan view of another heel pad according to an example embodiment. Referring to FIG. 20, the heel pad 470 may have an octagonal shape (so as to resemble a stop sign), and the heel pad 480 may be in a form of a forward arrow. The heel pad 480 may be green in color and secured to the floor mat below the gas pedal, while the heel pad 470 may be red in color and secured to the floor mat below the brake pedal, although example embodiments are not limited thereto.

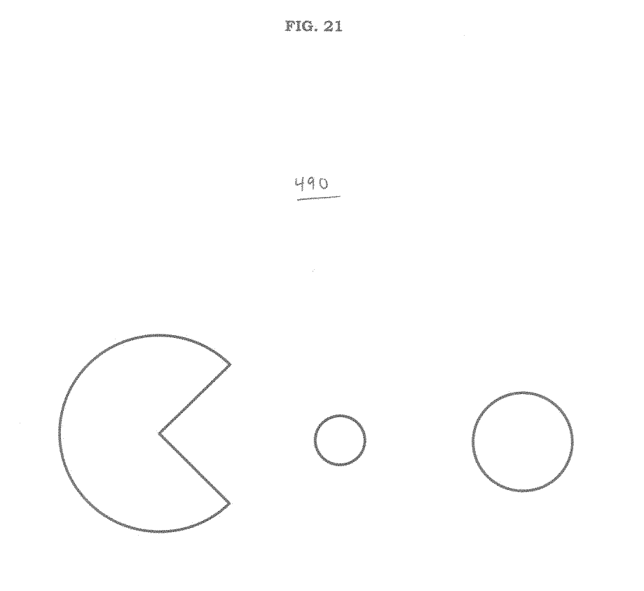

FIG. 21 is a plan view of another heel pad according to an example embodiment. Referring to FIG. 21, the heel pad 490 may be in the form of a three-quarter circle and two smaller whole circles (so as to resemble a pac-man character heading towards a pac-dot and a power pellet). The heel pad 490 corresponding to the right whole circle (power pellet) may be secured to the floor mat below the gas pedal, the heel pad 490 corresponding to the center whole circle (pac-dot) may be secured to the floor mat below the brake pedal, and the heel pad 490 corresponding to the three-quarter circle (pac-man character) may be secured to the floor mat below the clutch pedal (for manual transmission vehicles), although example embodiments are not limited thereto.

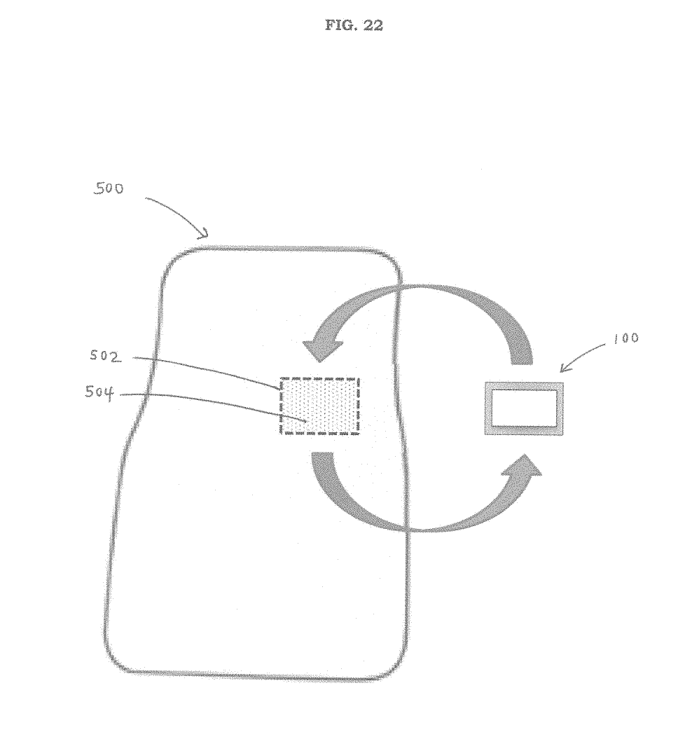

FIG. 22 is a plan view of a floor mat with a replaceable heel pad section according to an example embodiment. Referring to FIG. 22, the floor mat 500 may be used as the floor mat for the driver's side of a motor vehicle. The floor mat 500 may be manufactured to include an opening or a recess 502 that is designed to receive a heel pad. The size and shape of the recess 502 is designed to correspond to the size and shape of the heel pad such that the heel pad is intimately seated within the recess 502 so as to have little or no room for maneuvering after seating. In an example embodiment, the recess 502 occupies no more than 15% of the surface of the floor mat 500 on which the recess 502 is disposed. The recess 502 includes an engagement area 504 designed for the attachment of the heel pad. The engagement area 504 may include or otherwise be configured to interact with a variety of structures for securing the heel pad, such as pointed protrusions, mating arrangements (e.g., snap-fit combinations), hook-and-loop fasteners (e.g., Velcro), and adhesives. The heel pad to be secured to the engagement area 504 may be the heel pad 100 in FIGS. 1-2.

In an example embodiment, the engagement area 504 may be larger than the recess 502. In such an instance, the engagement area 504 may extend beneath the exterior of the floor mat 500 so as to be partially overlapped, thereby forming a shallow pocket configured to receive the second area 104 when the heel pad 100 is inserted into the recess 502. As a result, when the heel pad 100 is inserted into the recess 502, the second area 104 of the heel pad 100 is substantially or completely hidden from view by the exterior of the floor mat 500, while the first area 102 of the heel pad 100 is visible and adjacent to the area of the floor mat 500 defining the recess 502.

In another variation, shallow pockets may be provided only along the opposing upper and lower sides (e.g., the opposing long sides) of the recess 502. In such an instance, the heel pad 100 may be modified such that the second area 104 is only provided along the opposing upper and lower sides (e.g., the opposing long sides) of the heel pad 100, while the first area 102 is elongated to fill the area previously occupied by the second area 104 along the opposing left and right sides (e.g., the opposing short sides) of the heel pad 100.

If the above shallow pockets will not be employed, then the second area 104 of the heel pad 100 may be omitted and the first area 102 may be enlarged to compensate for the omission. In particular, the floor mat 500 can be structured such that, when the heel pad 100 is seated within the recess 502, the upper surface of the heel pad 100 will be about level with the upper surface of the floor mat 500. As a result, the transitional section (e.g., tapered shape) provided by the second area 104 will not be needed in this instance.

The backing or support structure of the floor mat 500 may be exposed by the recess 502. In this regard, if the backing or support structure of the floor mat 500 is made of a woven or fibrous material, then the engagement area 504 will be the woven or fibrous section. In such an instance, the engagement structure 106 of the heel pad 100 may be in the form of pointed protrusions (e.g., teeth) that enable the attachment of the heel pad 100 to the engagement area 504. In another instance, the engagement structure 106 of the heel pad 100 may be in the form of hooks configured to catch in the material (e.g., loops of fiber) of the engagement area 504 of the floor mat 500 when the heel pad 100 is secured to the floor mat 500. The plurality of hooks used as the engagement structure 106 may be the same as those in a standard hook-and-loop fastener (e.g., Velcro). The engagement area 504 may also be provided with a material that is different from the material of the backing or support structure of the floor mat 500 to facilitate the attachment of the heel pad 100. For instance, if a polymer film or other smooth material is in the engagement area 504, then the engagement structure 106 of the heel pad 100 may be in the form of an adhesive.

In another instance, if the backing or support structure of the floor mat 500 if formed of a polymer, then the engagement area 504 exposed by the recess 502 may be provided with a snap-fit arrangement or other mating arrangement for coupling with the engagement structure 106 of the heel pad 100. For instance, the engagement structure 106 of the heel pad 100 may include one or more male members that are configured to engage with one or more corresponding female members in the engagement area 504 of the floor mat 500 to form a snap-fit or friction-fit arrangement. In another instance, the engagement structure 106 of the heel pad 100 may include a first array of teeth that are configured to engage with the interstices of a second array of teeth in the engagement area 504 of the floor mat 500 to form an interlocking arrangement. In another instance, the engagement structure 106 of the heel pad 100 may include a first set of ridges (e.g., horizontal zigzagging or wavy ridges) that are configured to engage with the furrows of a second set of ridges (e.g., horizontal zigzagging or wavy ridges) in the engagement area 504 of the floor mat 500 to form an anti-skid arrangement. In another instance, the engagement structure 106 of the heel pad 100 may include a first magnet (or a plurality thereof) that is attracted to a second magnet (or a plurality thereof) in the engagement area 504 of the floor mat 500 to form a magnetic connection.

A number of variations and combinations for the configuration of the heel pad, the configuration of the floor mat, and the engagement of the heel pad to the floor mat are possible, and not all possible variations and combinations have been expressly disclosed herein. In this regard, it should be understood that the features disclosed in connection with one example may be applicable to another example. Due to the replaceable nature of the heel pad disclosed herein, the floor mat of a motor vehicle can be protected while also providing an aesthetic appeal.

While a number of example embodiments have been disclosed herein, it should be understood that other variations may be possible. Such variations are not to be regarded as a departure from the spirit and scope of the present disclosure, and all such modifications as would be obvious to one skilled in the art are intended to be included within the scope of the following claims.

1. A heel pad for a floor mat of a motor vehicle, comprising:
a first section including a first material;
a second section including a second material and disposed along a periphery of the first section; and
an engagement structure below at least one of the first section and the second section.

2. The heel pad of claim 1, wherein the first section has a thickness of 0.5 inches or less.

3. The heel pad of claim 1, wherein the first material is a different type from the second material.

4. The heel pad of claim 3, wherein the first material is of a fibrous construction, and the second material is a polymer.

5. The heel pad of claim 1, wherein the first material is a same type as the second material.

6. The heel pad of claim 1, wherein the second section has a tapered edge.

7. The heel pad of claim 1, wherein the second section is more dense than the first section.

8. The heel pad of claim 1, wherein the engagement structure is in a form of a plurality of protrusions.

9. The heel pad of claim 1, wherein the engagement structure is in a form of a plurality of hooks.

10. The heel pad of claim 1, wherein the engagement structure is in a form of an adhesive.

11. The heel pad of claim 1, wherein the second section includes an upper surface and an opposing lower surface, the upper surface of the second section defines a depression, the first section is seated in the depression, and the engagement structure is attached to the opposing lower surface of the second section.

12. The heel pad of claim 1, further comprising:
a support structure including an upper surface and an opposing lower surface,
wherein the first section and the second section are attached to the upper surface of the support structure, and the engagement structure is attached to the opposing lower surface of the support structure.

13. A floor mat of a motor vehicle, comprising:
a flexible laminar body defining a recess configured to receive a replaceable protective pad.

14. The floor mat of claim 13, further comprising:
an engagement structure within the recess, the engagement structure including at least one of a plurality of male members, a plurality of female members, a hook portion of a hook-and-loop fastener, a loop portion of the hook-and-loop fastener, an adhesive, and a magnet.

15. The floor mat of claim 14, wherein the flexible laminar body includes a backing structure and a fibrous layer on the backing structure, the fibrous layer defining an opening as the recess, the opening exposing a sector of the backing structure, the sector of the backing structure exposed by the opening including the engagement structure.

16. The floor mat of claim 14, wherein the flexible laminar body and the engagement structure are integrally formed.

17. The floor mat of claim 13, wherein the recess includes a shallow pocket that is overlapped by the flexible laminar body.

18. The floor mat of claim 13, further comprising:
a heel pad seated within the recess as the replaceable protective pad.

19. A method of protecting a floor mat of a motor vehicle, comprising:
attaching a heel pad to a portion of the floor mat below a pedal of the motor vehicle so as to be situated between a heel of a driver of the motor vehicle and the floor mat.

20. The method of claim 19, wherein the attaching includes securing the heel pad to the portion of the floor mat that is primarily subject to repetitive contact with the heel of the driver.
